(19) United States
(12) Patent Application Publication
(10) Pub. No.: US 2018/0079661 A1
(43) Pub. Date: Mar. 22, 2018

(54) POLYMER AND POLYMER LOADED MATERIALS FOR SCAVENGING ENVIRONMENTAL POLLUTANTS FROM NATURAL WATER SOURCES

(71) Applicant: Mark P. Banister, Tucson, AZ (US)

(72) Inventor: Mark P. Banister, Tucson, AZ (US)

(21) Appl. No.: 15/560,947

(22) PCT Filed: Mar. 24, 2016
(86) PCT No.: PCT/US16/24073

§ 371 Date: Sep. 22, 2017

Related U.S. Application Data
(60) Provisional application No. 62/137,552, filed on Mar. 24, 2015.

(51) Int. Cl. C02F 1/28; C08G 81/02; C09D 187/00; B01J 20/26; B01J 20/28; C02F 1/46

(52) U.S. Cl. CPC C02F 1/285; C08G 81/024; C09D 187/005; B01J 20/262; C02F 2103/08; B01J 20/28023; C02F 1/4604; C08G 2340/00; B01J 20/28033

(57) ABSTRACT

A hydrophilic polymer matrix wherein the polymer matrix comprises one or more monomers or polymers selected from the group consisting of Diglycidyl Ethers, Polyacrylamides, Polyvinyls, Polysaccharides, Polyesters, Esters, Polyethylene Glycols, Polypropylene Glycols, Butanediols, Epoxides or other hydrophilic polymers that are crosslinked to form a flexible non-soluble polymer matrix that has more than one excess or unreacted molecule and wherein excess molecules are available or have electrons available for one or more charge coupling or bonding reactions that are reversible, with one or more target molecules such as but not limited to salts, chlorides, acids and or ion species solvated in water or other solvent.

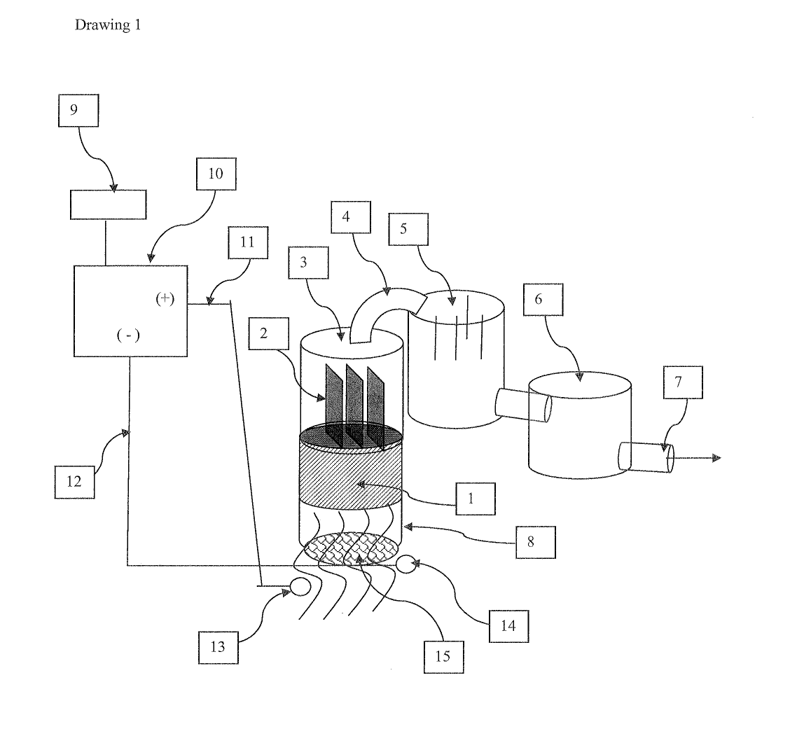

One of the largest problems facing global Industries such as mining and agriculture food production is the residual pollution from these endeavors. Acidic mine tailings contain many dissolved metals that are very hazardous to humans and our ecosystem. Once these dissolved metals enter the watershed they are extremely difficult to contain and can pollute drinking water sources, aquifers rivers lakes and streams killing or polluting many forms of wildlife and tainting food sources.

The use of pesticides, soil surface applied fertilizers and effluent from livestock areas in the agriculture industry are also major contributors to watershed pollution. The nitrate and phosphorus rich water runoff pollutes groundwater supplies of drinking water, as well as streams, rivers, lakes, and ocean environments where it causes eutrophication. Eutrophication has rapidly become a growing global environmental problem causing algae blooms that are disastrous to aquatic life ecosystems.

Since the common transport link, to many of these pollutants is water, this invention pertains to low cost materials and methods that provide a way to strip pollutants away from the very water the pollutants are soluble in. Disclosed are materials, methods, substrates for materials as well as materials and methods for reclaiming the pollutants back from the disclosed materials and substrates so that they can be reused several times, and for producing lean water.

The polymer chemistry of hydrogels is well known but hydrogels have not been designed to attract pollutant chemicals solvated in water. This invention is the addition of excess unreacted molecules to hydrogels or more specifically the hydrogel polymer matrix in order to attract and retain the targeted pollutants until such time that the target pollutants are desired to be released via exposure to another solution or solvent that will change the molecular charges of the excess reactive molecules and release the pollutant molecules into the solution or solvent. The solution or solvent may be an aqueous based solvent or non aqueous solution or solvent with a different pH than the polymer matrix.

In a further refinement of the invention the polymer matrix is part of a device for purifying water in particular, but not limited to fresh water, waste water, industrial waste water, brackish water and sea water.

By designing cross linked polymers that have excess reactive molecules within the polymer matrix, whether the molecules are trapped within the matrix or part of a polymer chain or linked to the outside surfaces of the polymer matrix, the polymers can have functional molecular charges left available, after the polymer cross linking process. The functional, or for the purpose of this description, available molecules have a polar charge that will act as an attractant for the pollutant molecule dependent on the pollutant molecular charge polarity. Current technologies such as ion membranes or ion exchange media are limited by the ion species they are designed to exchange, in other words they swap one ion species for another safer species of the charge state of positive or negative but not both. The described invention improves this process by attracting both positive and negative ion species by using excess reactive molecules in or on the polymer, and holding on to them until released via chemical or electrochemical, heat or other process. This allows the polymer material to be used to remove multiple dissolved pollutants at the same time with one material formulation. This works especially well when water is the solvating solution the dynamics of the attraction are very fast and work very efficiently due to waters dipole charge.

The excess reactive molecule ratios of the polymer matrix can be varied in order to target specific molecules or the capacity of the material to attract and retain one or more specific molecules. By reacting just enough of the polymer crosslinking to generate a mechanically stable polymer matrix and leaving unreacted molecules on the ends of polymer chains or attached to the polymer chain. This can be done through many polymerization processes well known in the art but for descriptive simplicity and not limiting the invention, using an epoxy reaction between a linear polyethylene glycol diglycidyl ether and a branched polyethyleneimine or polyalkylamine polymer such as Jeffamine by Huntsman chemical, wherein both polymers are water soluble and crosslink readily in the presence of water as the catalyst.

The porosity and reactive molecule ratio of the resulting non soluble polymer matrix can be easily controlled by changing the ratio of each component in the formulation and the polymer chain lengths, the number of crosslinks depends on the amount of the diglycidyl ether as the branched polyethyleneimine has a set number of branches containing primary secondary and tertiary amines or reactive NH units. The reactive oxygen's on the ends of the PEG chain of the diglycidyl ether react readily with the hydrogen on the imines, amines etc. so by adding more or less of each component you can control the ratio of excess reactive molecules that are attached to the polymer matrix, this is only limited by minimal amount crosslinking needed to be structurally sound for the intended use of the polymer.

Ratios of reactive molecules such as but not limited to Oxygens, Hydroxyls, Amines, Nitrates, Carbons, Flourines, Ammonias, Hydrogens and alternate forms of these molecules can vary greatly with the addition of hyperbranched and dendritic polymers where each generation of branches can vastly increase the number of reactive end units on the branches that end up being not reacted in the polymerization process.

Hyperbranched polyesters with OH end units can be added to the above formulations and change the properties of the materials response due to the change of the ratio between the excess reactive NH and OH units. The ratio determines the charge attraction in water and can be tailored to the pollutant in water that is being recovered ie, the higher the NH ratio the more acidic or low pH scavenging. The higher the OH ratio the more basic or high pH scavenging the material becomes. The resulting polymer material will also attract and hold onto both positive and negative ion species in amounts that are dependent to the number and type of reactive molecules available.

In one aspect the present invention provides a hydrophilic polymer matrix wherein the polymer matrix comrpises one or more monomers or polymers selected from the group consisting of Diglycidyl Ethers, Polyacrylamides, Polyvinyls, Polysaccharides, Polyesters, Esters, Polyethylene Glycols, Polypropylene Glycols, Butanediols, Epoxides or other hydrophilic polymers that are crosslinked to form a flexible non-soluble polymer matrix that has more than one excess or unreacted molecule and wherein excess molecules are available or have electrons available for one or more charge coupling or bonding reactions that are reversible, with one or more target molecules such as but not limited to salts, chlorides, acids and or ion species solvated in water or other solvent. In such aspect, the hydrophilic polymer matrix preferably comprises a hydrophilic polymer that is coating or crosslinked to a substrate made of natural or synthetic material, in the form of a cloth, fiber or filter media wherein the polymer has more than one excess or unreacted molecules that are available or have electrons available for one or more coupling or bonding reaction that is reversible with one or more target molecules solvated in water or other solvent, or a hydrophilic polymer that is coating or crosslinked to a substrate made of natural or synthetic material, in the form of a cloth, fiber or filter media, wherein the substrate is biodegradable and wherein the polymer matrix has a biodegradable backbone and has more than one excess or unreacted molecules that are available or have electrons available for one or more coupling or bonding reaction that is reversible with one or more target molecules solvated in water or other solvent.

The invention also provides a non-soluble hydrophilic polymer matrix that is formed when a linear di-epoxide polymer is reacted with a branched Polyethylene or polypropylene polymer with NH2 or NH or other H molecule units that are available to react and crosslink with a hydrophilic di-epoxide and wherein the polymer has more than one excess or unreacted molecules that are that are left available after the crosslink reaction or have electrons available for one or more coupling or bonding reactions that are reversible, with one or more target pollutant molecules solvated in water or other solvent.

In yet another aspect the invention provides a non-soluble hydrophilic polymer matrix that is formed when a linear diamine polymer is reacted with a branched Polyethylene or polypropylene with epoxide or epoxy or other molecule units that are available to react and crosslink with the diamine and wherein the polymer has more than one excess or unreacted molecules that are that are left available after the crosslink reaction or have electrons available for one or more coupling or bonding reactions that are reversible, with one or more target pollutant molecules solvated in water or other solvent and wherein the polymer matrix is coating or crosslinked to a substrate cloth, fiber or filter media.

In still yet another aspect, the invention provides a hydrophilic polymer made of an epoxy formed from the reaction of polyethylene glycol diglycidyl ether and a branched polymer with amine or imine terminals werein the polymer is coating or crosslinked to a substrate cloth consisting of woven fibers, wherein the fiber is biodegradable and wherein the polymer has more than one excess or unreacted molecules that are available or have electrons available for a coupling reaction that is reversible with one or more target molecules solvated in water or other solvent.

In all such aspects of the invention, the substrate cloth preferably comprises woven or non-woven fibers of essentially any diameter or combination of diameters that are woven in a range from 1 to 100 threads per square inch resulting in an open weave pattern of any geometric size direction or shape.

The present invention also provides a hydrophilic polymer that can reversibly change color via contact with one or more pollutants and wherein the polymer is coating or crosslinked to a substrate cloth, fibers, or filter media wherein the substrate is molded to form a geometric shape prior to the polymers completing the crosslink reaction and upon finishing crosslinking the substrate cloth or fibers maintain the molded shape.

Also provided is a hydrophilic polymer that can reversibly change color via contact with one or more pollutants and wherein the polymer is coating or crosslinked to a substrate cloth, fibers, or filter media wherein the substrate is molded to form a geometric shape prior to the polymers completing the crosslink reaction and upon finishing crosslinking the substrate cloth or fibers maintain the molded shape and are used as a mat that polluted water comes into contact with and the mat becomes saturated with the target pollutant molecules, wherein the mat can be processed via washing with another electrochemical process, chemical, solvent, water or combination of these to remove the target pollutant molecules and the mat can be reused to collect more pollutants.

In yet another embodiment there is provided a hydrophilic polymer that can change color reversibly via contact with one or more pollutant molecules and wherein the polymer is coating or crosslinked to a substrate cloth, fibers or filter media wherein the substrate is used as a mat or device that the polluted water comes into contact with and the mat becomes saturated with the target pollutant molecules, wherein the mat can be processed via washing with another electrochemical process, chemical, solvent, water or combination of these to remove the target pollutant molecules and the mat can be reused. And wherein the target pollutant molecules such as but not limited to metals can be recovered from the wash solution via electrochemistry, evaporation, saturation precipitation or other types of chemistry separation processes.

The present invention also provides a hydrophilic polymer loaded substrate cloth, fibers or filter media wherein the substrate is used as a mat or device that the polluted water comes into contact with and the mat becomes saturated with the target pollutant molecules and wherein the target pollutant molecules can be used by another organism and or enzyme as food, energy, nutrients, catalyst and or part of a growing or nutrient cycle. In such embodiment, the organism or plant roots preferably may penetrate the mat wherein the mat slows down the ability of water to evaporate out of the soil or plant media thereby conserving water for the organism or plant.

The present invention also provides a hydrophilic polymer loaded substrate cloth, fibers or filter media wherein the substrate is used as a mat or device mat that absorbs and releases water over a desired period of time, wherein the period of time is controlled be the polymer density, porosity, polymer chain length and molecular affinity for water. In such embodiment, the polymer loaded substrate preferably may be used in contact with agriculture runoff to remove Ammonia, Nitrate, Nitrite, Phosphorus, Potassium or other components from agriculture runoff water and allow water to pass through or over the substrate.

The present invention also provides a polymer loaded substrate cloth, fibers or filter media are chopped up after they are loaded with polymer and wherein the polymer loaded substrate cloth or fibers are made of one or more of the following but not limited to the following cotton, burlap, coconut fiber, wood and bark strands, natural materials, man made materials, polyester, polypropylene, polyethylene all in singular or combinations of woven and or non woven materials and mixed with potting soils and or media for agriculture use as a growing media.

In still another embodiment, the invention provides use of a hydrophilic polymer matrix loaded substrate cloth, fibers or filter media are used as a method wherein the polymer loaded substrate absorbs and releases water over a desired period of time, wherein the period of time is controlled be the polymer density, porosity, polymer chain length and molecular affinity for water and the desired pollutant and wherein the polymer loaded substrate is used for mining to retain solvated metals and other solvated chemicals in contact with ground water and or runoff water and allow the water to pass through the substrate but retain the target pollutants. In a preferred embodiment, of such use, the polymer matrix may be ground or milled to produce granules of varying size, and wherein the granules are contained within a porous bag and or container in contact with water or solvent to remove one or more targeted pollutants. In such embodiment, the polymer matrix may be contained within a porous bag and or container in contact with water to buffer the pH of the water, and/or to strip CO2 or other acids from water, brackish water or sea water.

The present invention also provides for the use of polymer matrix of the invention wicking mechanism in a water purification device wherein the polymer matrix absorbs the water and at a determined rate wicks the water into an evaporation chamber the high surface area of the polymer matrix increases the evaporation rate substantially faster than that of standing water and wherein the polymer matrix is also antimicrobial and anti fungal due to the excess reactive molecules.

Finally, the present invention provides a hydrophilic polymer loaded substrate cloth, fibers or filter media for use as a wicking mechanism in a water purification device wherein the polymer matrix absorbs the water and at a determined rate wicks the water into an evaporation chamber the high surface area of the polymer matrix increases the evaporation rate substantially faster than that of standing water and wherein the polymer matrix is also antimicrobial and anti fungal due to the excess reactive molecules and wherein the evaporated water is re-condensed for use.

In a further refinement of the invention the polymer matrix is part of a device for purifying water as shown in Drawing 1

The previously described hydrophilic polymer matrix (1) is used as a wicking mechanism in a water purification device. The polymer matrix absorbs the water from the water inlet (8) and at a determined rate wicks the water into an evaporation chamber (3) the high surface area of the polymer matrix increases the evaporation rate substantially faster than that of standing water. The polymer matrix is also antimicrobial and anti-fungal due to the excess reactive molecules.

One or more polymer matrixes are allowed to contact the unpurified water. The polymer matrixes absorb the un purified water and wicks it into an evaporation chamber. Nano porosity of the polymer filters the water and stops any transfer of bacteria or solids or other contaminates. The evaporation chamber or 1^{st} chamber is curved and or angular at the top and in fluid connection (4) with a higher 2^{nd} condensation chamber (5) so that evaporated water travels into the second chamber and condenses. The condensate water collects or drips into a 3rd collection chamber (6) that is in fluid connection to the 2^{nd} chamber. The 2^{nd} condensation chamber may or may not contain one or more fibers used to increase condensation rate by adding more surface area for the evaporated water to cool on and condense.

The 3^{rd} collection chamber has an outlet (7) with a valve to allow release of the stored purified water that can be used for drinking or other things.

The water purification device additionally has a first section that contains one or more screens (15) for filtering large debris from entering the device. The 1^{st} section has an inlet side (8) for un purified water to enter and an outlet side that is in fluid connection with the polymer matrix and exposes the un purified water to the polymer matrix. Within the first section there are one or more electrodes, positive (13) and negative (14) the electrodes are in electrical connection (11 & 12) with an electrical power source (9) and controller (10) to control the amount of power that is sent to the electrodes. The electrodes are made of a conductive material such as a metal graphite or carbon. Electrical power is applied to the electrodes to attract and collect the ions of the dissolved salts and minerals within the brackish or saltwater prior to entering the polymer matrix. The one or more polymer matrixes can be removed for cleaning, due to the polymer matrixes elastomeric nature the material can be dried so that any impurities stuck to it will easily clean off due to the change in surface area and tension. In a preferred embodiment the complete device is manufactured of plastic, stainless steel or other easily manufactured materials well known in the art and assembled with standard plumbing components, that can accommodate for the change in temperature and humidity of the water from evaporation to condensation and collection. The polymer matrixes can be molded to a specific geometric shape (2) and size for the device. the polymer matrix can also be loaded onto a high surface area substrate in liquid form prior to polymer crosslinking that fits into the device to increase surface area and evaporation rate. A fan can be added to increase flow of water vapor into condensation chamber.

This invention is not to be limited in any way by the description as any combination of the preferred embodiments that can be useful and of value as water storing processing and purification applications with multiple uses for water treatment in industry, agriculture and aquaculture.

1-17. (canceled)

18. A hydrophilic polymer matrix wherein the polymer matrix comprises one or more monomers or polymers selected from the group consisting of Diglycidyl Ethers, Polyacrylamides, Polyvinyls, Polysaccharides, Polyesters, Esters, Polyethylene Glycols, Polypropylene Glycols, Butanediols, Epoxides or other hydrophilic polymers that are crosslinked to form a flexible non-soluble polymer matrix that has more than one excess or unreacted molecule and wherein excess molecules are available or have electrons available for one or more charge coupling or bonding reactions that are reversible, with one or more target molecules such as but not limited to salts, chlorides, acids and or ion species solvated in water or other solvent.

19. The hydrophilic polymer matrix of claim 18, wherein the hydrophilic polymer is a coating or crosslinked to a substrate made of natural or synthetic material, in the form of a cloth, fiber or filter media wherein the polymer has more than one excess or unreacted molecules that are available or have electrons available for one or more coupling or bonding reaction that is reversible with one or more target molecules solvated in water or other solvent.

20. The hydrophilic polymer matrix of claim 18, wherein the hydrophilic polymer is a coating or crosslinked to a substrate made of natural or synthetic material, in the form of a cloth, fiber or filter media, wherein the substrate is biodegradable and wherein the polymer matrix has a biodegradable backbone and has more than one excess or unreacted molecules that are available or have electrons available for one or more coupling or bonding reaction that is reversible with one or more target molecules solvated in water or other solvent.

21. The hydrophilic polymer matrix of claim 19, wherein the substrate comprises woven or non-woven fibers of any diameter or combination of diameters that are woven in a range from 1 to 100 threads per square inch resulting in an open weave pattern of any geometric size, direction or shape.

22. The hydrophilic polymer matrix of claim 20, wherein the substrate comprises woven or non-woven fibers of any diameter or combination of diameters that arc woven in a range from 1 to 100 threads per square inch resulting in an open weave pattern of any geometric size, direction or shape.

23. A method for forming a hydrophilic polymer matrix, which method comprises:
(a) reacting a linear di-epoxide polymer with a branched polyethylene or polypropylene polymer with NH2 or NH or other H molecule units that are available to react and crosslink with a hydrophilic di-epoxide and wherein the polymer has more than one excess or unreacted molecules that are that are left available after the crosslink reaction or have electrons available for one or more coupling or bonding reactions that are reversible, with one or more target pollutant molecules solvated in water or other solvent; or
(b) reacting a linear diamine polymer with a branched polyethylene or polypropylene with an epoxide or epoxy or other molecule units that are available to react and crosslink with the diamine and wherein the polymer has more than one excess or unreacted molecules that are that are left available after the crosslink reaction or have electrons available for one or more coupling or bonding reactions that are reversible, with one or more target pollutant molecules solvated in water or other solvent and wherein the polymer matrix is coating or crosslinked to a substrate cloth, fiber or filter media; or
(c) reacting a polyethylene glycol diglycidyl ether and a branched polymer with amine or imine terminals werein the polymer is coating or crosslinked to a substrate cloth consisting of woven fibers, wherein the fiber is biodegradable and wherein the polymer has more than one excess or unreacted molecules that are available or have electrons available for a coupling reaction that is reversible with one or more target molecules solvated in water or other solvent.

24. The method of claim 23(b), wherein the substrate cloth comprises woven or non-woven fibers of any diameter or combination of diameters that are woven in a range from 1 to 100 threads per square inch resulting in an open weave pattern of any geometric direction or shape.

25. The method of claim 23(c), wherein the substrate cloth comprises woven or non-woven fibers of any diameter or combination of diameters that are woven in a range from 1 to 100 threads per square inch resulting in an open weave pattern of any geometric direction or shape.

26. A hydrophilic polymer that can reversibly change color via contact with one or more pollutants and wherein the polymer is coating or crosslinked to a substrate cloth, fibers, or filter media wherein the substrate is molded to form a geometric shape prior to the polymers completing the crosslink reaction and upon finishing crosslinking the substrate cloth or fibers maintain the molded shape.

27. The hydrophilic polymer of claim 26, used as a mat that polluted water comes into contact with and the mat becomes saturated with the target pollutant molecules, wherein the mat can be processed via washing with another electrochemical process, chemical, solvent, water or combination of these to remove the target pollutant molecules and the mat can be reused to collect more pollutants, and/or wherein the target pollutant molecules such as but not limited to metals can be recovered from the wash solution via electrochemistry, evaporation, saturation precipitation or other types of chemistry separation processes.

28. A hydrophilic polymer loaded substrate cloth, fibers or filter media wherein the substrate:
(a) is used as a mat or device for cleaning polluted water, wherein the polluted water is brought into contact with the mat or device which becomes saturated with the target pollutant molecules and wherein the target pollutant molecules can be used by another organism and or enzyme as food, energy, nutrients, catalyst and or part of a growing or nutrient cycle, and wherein the organism or plant roots may penetrate the mat wherein the mat slows down the ability of water to evaporate out of the soil or plant media thereby conserving water for the organism or plant; or
(b) is used as a mat or device mat for controlled release of water, wherein the mat or device is adapted to absorb and release water over a desired period of time, wherein the period of time is controlled by polymer density, porosity, polymer chain length and molecular affinity for water, and optionally wherein the polymer loaded substrate is used in contact with agriculture runoff to remove ammonia, nitrate, nitrite, phosphorus, potassium or other components from agriculture runoff water and allow water to pass through or over the substrate.

29. A polymer loaded substrate cloth, fibers or filter media which are loaded with polymer and then chopped up, wherein the polymer loaded substrate cloth or fibers are made of a material selected from the group consisting of cotton, burlap, coconut fiber, wood and hark strands, natural materials, man made materials, polyester, polypropylene, polyethylene and a mixture of two or more thereof, in singular or combinations of woven and or non woven materials and mixed with potting soils and or media for agriculture use as a growing media.

30. A method for absorbing and releasing water over a period of time, comprising providing a hydrophilic polymer mixture loaded substrate cloth, fibers or filter material, wherein the period of time is controlled by polymer density, porosity, polymer chain length and molecular affinity for water and the desired pollutant and wherein the polymer loaded substrate is used for mining to retain solvated metals and other solvated chemicals in contact with ground water and or runoff water and allow the water to pass through the substrate but retain the target pollutants.

31. The method according to claim 30, wherein the polymer matrix is ground or milled to produce granules of varying size, and wherein the granules are contained within a porous hag and or container in contact with water or solvent to remove one or more targeted pollutants, and optionally wherein polymer matrix is contained within a porous hag and or container in contact with water to buffer the pH of the water, and/or to strip CO2 or other acids from water, brackish water or sea water.

32. The hydrophilic polymer matrix of claim 18, used as a wicking mechanism in a water purification device wherein the polymer matrix absorbs the water and at a determined rate and wicks the water into an evaporation chamber, wherein the high surface area of the polymer matrix increases the evaporation rate substantially faster than that of standing water, and wherein the polymer matrix is also antimicrobial and anti fungal due to the excess reactive molecules.

33. The hydrophilic polymer matrix of claim 18. loaded on a substrate cloth, fibers or filter and, wherein the evaporated water is re-condensed for reuse
